(19) United States
(12) Patent Application Publication
(10) Pub. No.: US 2011/0043378 A1
(43) Pub. Date: Feb. 24, 2011

(54) TRAFFIC CONTROL SYSTEM

(75) Inventors: Marshall Graham Bailey, Newcastle upon Tyne (GB); James Bailey, Newcastle upon Tyne (GB)

Correspondence Address: SNELL & WILMER L.L.P. (Main), 400 EAST VAN BUREN, ONE ARIZONA CENTER, PHOENIX, AZ, 85004-2202, US

(73) Assignee: HATTON TRAFFIC MANAGEMENT LTD, Tyne & Wear (GB)

(21) Appl. No.: 12/866,407

(22) PCT Filed: Jan. 30, 2009
(86) PCT No.: PCT/GB09/00272

§ 371 Date: Nov. 11, 2010

(30) Foreign Application Priority Data
Feb. 6, 2008 (GB) 0802205.5

(51) Int. Cl. G08G 1/07

(52) U.S. Cl. 340/917

(57) ABSTRACT

A traffic control system comprises at least one signal unit, at least one detector, control means for controlling the timings of signals displayed by the at least one signal unit in dependence upon output from the at least one detector, and means for determining the position of the or each detector.

The present invention relates to a traffic control system, and in particular to a control and monitoring system for temporary or permanent traffic signals.

Temporary traffic lights are used in many different situations where normal traffic flow is disrupted, for instance around roadworks or other traffic obstructions, or to provide additional traffic flow control when large additional volumes of traffic are expected.

Known sets of temporary traffic signals comprise a set of signal heads, each for controlling traffic flow through a respective traffic leg. Operation of the signal heads is controlled using a signal controller which controls the cyclical display of red, amber and green signals on the signal heads.

In the simplest control system, green and red times for each signal head in each signal cycle have a fixed length, which may be set, for instance, at the time of installation of the temporary traffic lights.

In an alternative known control system for temporary traffic lights, each signal head has associated with it an above ground detector (AGD) in the form of a microwave sensor mounted on the signal head, for sensing the presence of a vehicle. The control system may operate a vehicle actuation (VA) method. A minimum green time is set, which defines the minimum length of time that each signal head displays a green signal during each signal cycle. The green time for a particular signal head is extensible beyond the minimum green time, and up to a maximum green time, if one or more vehicles are detected by the sensor for that signal head. Alternatively or additionally, after each signal cycle all signal heads are turned to red and maintained on red until a vehicle is detected by a sensor for one of the signal heads. The signal cycle is then operated, with the first green signal of the cycle being displayed on the signal head for which the presence of a vehicle has been detected.

To date, it has generally not been feasible to set optimum green and red times for temporary traffic lights, as the relative traffic volumes, and likely variation in the traffic volumes, are not known. Traffic survey figures for the location where the temporary traffic lights are to be installed may well not be available, and are of limited use even if available as, generally, temporary traffic lights are associated with obstructions to normal traffic flows or abnormal traffic flow situations. The known control systems for temporary traffic lights are, in any event, not adapted to cope with situations in which the volumes of traffic from different directions are significantly different, or to deal with large fluctuations in traffic volumes. Congestion can therefore build up at temporary traffic lights, causing frustration amongst drivers and encouraging risky driving manoeuvres. The presence of temporary traffic lights may also cause significant variations in traffic flows, and traffic congestion, in other parts of a traffic network.

It is known to use equivalent control systems to those described above for permanent traffic lights as well as for temporary traffic lights, based upon fixed green or red times, or upon vehicle actuation (VA) with minimum and extensible green times. Vehicle actuation (VA) methods for permanent traffic lights may use one, two or three vehicle detectors associated with each signal head, at different distances from the signal head. The vehicle detectors may be below ground detectors, such as buried inductive loop detectors, or above ground detectors, such as microwave or infrared detectors.

The microprocessor optimised vehicle actuation (MOVA) system is an example of a more sophisticated vehicle actuation (VA) system. The system includes a pair of below-ground detectors associated with each signal head, one located at a greater distance from the stop line than the other. Vehicles are counted over each pair of detectors, and estimates of vehicles queuing at or on the approach to a junction, for each leg of the junction, are obtained at any given time. During each stage of each signal cycle, the system decides whether, and for how long, to extend a particular green signal beyond the minimum green time in dependence upon the number of vehicles that have passed over the detectors at each leg of the junction. The MOVA system has two modes of operation, one of which is adapted for un-congested conditions, and the other of which is adapted for situations in which queues are present on one or more approaches to a junction.

The MOVA system generally operates to control a single set of traffic lights, although linked MOVA systems co-ordinating two or three closely-spaced, adjacent traffic signals have also been deployed, for instance at signal-controlled roundabouts. The system controller is installed locally in a control box associated with the set of traffic lights.

Linked set of traffic lights are also known, in which signal timings for different sets of traffic lights at different locations are linked, either by operation in dependence upon a common timing signal (for example derived mains frequency) or by communication between controllers for each set of traffic lights, linked together by cable.

In the known SCOOT system, a central traffic computer is used to set timings of signal cycles in a co-ordinated fashion for many different sets of traffic signals across a wide area, for instance across an entire city or city centre, based on the outputs from a network of induction loop detectors that detect the presence or absence of vehicles.

It is in general more straightforward to set appropriate green and red times for permanent traffic lights than is the case for temporary traffic lights, as likely traffic flows, in the absence of abnormal conditions, may be more predictable and as the effects of different signal timing cycles may be observed over a significant period of time.

It is an aim of the present invention to provide improved, or at least alternative, temporary and/or permanent traffic control systems.

In a first independent aspect of the invention there is provided a traffic control system comprising at least one signal unit, a plurality of detectors, and control means for controlling the timings of signals displayed by the signal units, wherein the control means is configured to monitor the value of at least one environmental or traffic-related parameter within at least one predefined monitoring zone and to control the timings in dependence upon the value of the at least one parameter.

Preferably each signal unit is a traffic light signal unit. Each parameter may represent an instantaneous or real-time quantity.

The at least one parameter preferably comprises at least one of traffic volume, traffic speed, traffic flow rate, queue length and waiting time. The parameter may be representative of the presence or absence of a vehicle to which priority should be given, for instance an ambulance, police car or fire engine.

The at least one environmental parameter may be, for example, representative of at least one of noise, pollution level, and/or concentration of one or more pre-determined compounds, temperature, windspeed, precipitation, and light level.

Preferably the control means is configured to determine the value of the at least one parameter in dependence upon outputs from the detectors.

The at least one predefined monitoring zone may comprise a plurality of monitoring zones. Preferably the traffic light system is for controlling flow of traffic into a control region, and each monitoring zone is associated with a different approach to a control region.

The system may be a temporary traffic control system, and each signal unit may be for controlling flow of traffic into a control region from a respective approach to the control region. Preferably a respective plurality of detectors is provided for each approach at different distances from the control region. Each approach to the control region may be a respective leg of a junction.

Each signal unit may be located at the edge of the control region. Each signal unit may have a respective stop line associated with it, and the control region may be delimited by the stop lines.

A single detector, or two detectors may be provided for each approach. Alternatively, between three and ten, or between four and eight detectors are provided for each approach.

In a further independent aspect of the invention there is provided a traffic control system comprising at least one signal unit and a plurality of detectors, wherein each signal unit is for controlling flow of traffic on a respective approach to a control region, and the system further comprises at least four detectors for each approach at different distances from the control region.

Each detector may be for detecting the presence or absence of a vehicle, preferably in real-time. Preferably each detector is an above ground detector, but one or more of the detectors may be below ground detectors.

Preferably each detector comprises a sensor for measuring a traffic-related parameter. Each detector may comprises a plurality of sensors. Preferably at least one of the plurality of sensors is for measuring an environmental parameter. Preferably each sensor is for measuring a parameter in real time.

Each detector may comprise for example, one or more of an acoustic sensor, proximity sensor, vibration sensor, visual recognition system, laser sensor, microwave sensor, induction loop sensor, capacitive sensor, pressure sensor, radar sensor, ultrasonic sensor, infra-red sensor, transponder, air quality sensor, RFID sensor, mobile phone, piezo-electronic sensor, magnetometer sensor and temperature sensor. Each detector may be operable to detect the presence or absence of a vehicle using sonar or radar. An RFID sensor may be configured to read radio frequency inductive (RFID) tags or devices that may be present on vehicles.

In a further independent aspect of the invention there is provided a traffic control system comprising at least one signal unit for displaying at least one traffic control signal, at least one sensor for measuring an environmental parameter, and control means for controlling the timing of display of the at least one traffic control signal in dependence on the measured environmental parameter.

In another independent aspect of the invention there is provided a detector for a traffic control system, comprising a plurality of sensors, wherein at least one of the sensors is for detecting the presence or absence of a vehicle, and at least one of the sensors is for measuring an environmental parameter.

Preferably each detector is included in a respective detector unit, preferably a self-contained detector unit.

The environmental parameter may comprise at least one of noise, pollution level, temperature, wind speed and precipitation. The environmental parameter may comprise the level of a particular substance, for instance a pollutant substance in the atmosphere. The substance may be, for instance, a by-product of operation of an internal combustion engine, and may be for instance carbon monoxide or a sulphur-based substance.

Preferably at least one signal unit and/or the control means and/or at least one detector comprises wireless communication means.

Preferably, each detector comprises wireless communication means. Alternatively the detectors may be grouped together, and each detector may be configured to communicate with at least one other detector in a group, and each group may include wireless communication means.

Preferably each detector is configured to provide its position to the control means.

In a further independent aspect of the invention, there is provided a traffic control system comprising at least one signal unit, at least one detector, control means for controlling the timings of signals displayed by the at least one signal unit in dependence upon output from the at least one detector, and means for determining the position of the or each detector.

The control means may be configured to control the timings of operation of the at least one signal unit in dependence upon the position of the at least one detector.

The position of each detector may comprise the absolute position of the detector or may comprise relative position, for example relative to the control means, relative to the or at least one of the signal units, or relative to at least one other of the detectors. The position of each detector may be the distance of the detector from a predetermined position, for example the distance of the detector to the control means, to the or at least one of the signal units, to a control region or to a stop line.

Each detector may comprise means for determining its position. The or each position-determining means may comprise GPS or GSM circuitry. Alternatively or additionally, each detector comprises a transmitter for transmitting a signal to a reference object and a receiver for receiving a response signal from the reference object, and a timing device for determining the time between transmission of the signal and receipt of the response signal, and the position determining means is configured to determine the position of the device relative to the reference object. The reference object may comprise another of the detectors and/or the control means and/or may be a reference object at or adjacent to a stop line or traffic junction.

The control means may be configured to use an algorithm to determine the timings of operation of the at least one signal unit, and may be further configured to select or alter the algorithm in dependence upon the position of the or each detector.

An algorithm in this context may be at least one or any combination of calculation, selection or process steps used to determine the timing of operation of the at least one signal unit. The algorithm may be implemented in hardware or software or any suitable combination of hardware and software.

The control means may be configured to use an algorithm to determine the timings of operation of the at least one signal unit, the algorithm may comprise at least one position dependent parameter, and the control means may be configured to set the value of the at least one position dependent parameter in dependence upon the position or positions provided by the at least one detector.

The at least one position dependent parameter may comprise the distance of the or each detector from a reference position.

The at least one position dependent parameter may comprise at least one traffic-related parameter or environmental parameter. The at least one traffic related parameter or environmental parameter may comprise at least one of traffic volume, traffic speed, traffic flow rate, queue length and waiting time, or may be, for example, representative of at least one of noise, pollution level, and/or concentration of one or more pre-determined compounds, temperature, windspeed, precipitation, and light level. The parameter may be representative of the presence or absence of a vehicle, for example a vehicle to which priority should be given, for instance an ambulance, police car or fire engine. The at least one environmental parameter may be, for example, representative of at least one of noise, pollution level, and/or concentration of one or more pre-determined compounds, temperature, windspeed, precipitation, and light level.

The control means may be configured to monitor the position of the detector or at least one of the detectors and to provide a signal in response to a change in position of the detector or at least one of the detectors.

The signal may comprise a fault signal and/or and alarm signal.

The controller may be configured to monitor the position of at least one of the detectors and to alter operation of the traffic control system in dependence on whether the position of the or at least one of the detectors changes.

The controller may be operable to control the timings of signals displayed by the at least one signal unit according to at least a first mode of operation and a second mode of operation, and may be configured to switch from the first mode of operation to the second mode of operation in dependence on whether the position of the detector or at least one of the detectors changes.

The second mode of operation may comprise using an algorithm to control the signal timings that is not dependent on the position of the at least one detector.

The first mode of operation may comprise a demand-responsive operation mode, and/or the second mode of operation may comprise one of a fixed time operation mode, an all-red operation mode and a manual operation mode.

The detector or at least one of the detectors may be configured to monitor its position and to transmit a change of position signal in response to a change in position.

Each detector may be configured to provide its position to the control means. Each detector may be configured to provide its position to the control means either directly, or indirectly (for example by transmission to another one of the detectors and retransmission by that other one of the detectors).

The or each detector may comprise communication circuitry. The communication circuitry may comprise wireless communication circuitry.

Each detector may comprise a detector processor configured to control the communication circuitry to transmit position data representative of the position of the detector.

At least one of the detectors may be configured to receive position data from at least one other of the detectors and to retransmit the position data. The at least one of the detectors is preferably configured to retransmit the position data to the control means.

The or each detector preferably comprises a vehicle detection sensor.

The vehicle detection sensor may be for detecting the presence or absence of a vehicle.

Alternatively or additionally, the vehicle detection sensor may be configured to determine the speed of a vehicle.

The system may comprise a plurality of signal units, and at least one of the detedtors may be associated with at least one of the signal units. At least one of the signal units may be for controlling traffic on a respective leg of a junction, and the at least one detector associated with that signal unit may be located at that leg of the junction. The at least one detector may be remote from its associated signal unit. The at least one detector may be located at a distance that is at least one of greater than 10 m, greater than 40 m or greater than 80 m from the signal unit.

In another independent aspect of the invention there is provided a traffic control system comprising at least one signal unit, at least one detector, and control means for controlling the timings of signals displayed by the at least one signal unit in dependence upon output from the at least one detector, wherein the control means is configured to receive position data representative of the position of the at least one detector.

The system may further comprise an operator interface device for communicating with an operator.

The control means may be configured to receive the position data via the operator interface device.

The control means may be configured to perform a system installation procedure comprising comparing the position of the or each detector to a predetermined position or range of positions and controlling the operator interface device to instruct the operator to move the detector or at least one of the detectors in dependence on the comparison.

The control means may be configured to perform a system installation procedure comprising selecting a mode of operation and/or selecting a traffic signal control algorithm and/or determining the value of a parameter used by a traffic signal control algorithm in dependence on the position of the at least one detector. The control means may subsequently control the timings of the signals displayed by the at least one signal unit in accordance with the selected mode of operation and/or traffic signal control algorithm.

The or each signal unit may be a temporary or portable signal unit.

The traffic control system may be a temporary or portable traffic control system. The detectors may be above ground detectors. Each detector may be included in a respective self-contained detector unit. Each detector may be remote from an associated signal unit.

In a further independent aspect of the invention there is provided a traffic control system comprising at least one signal unit, a plurality of detectors, and control means for controlling the timings of signals displayed by the at least one signal unit, wherein each detector is configured to provide its position to the control means.

Preferably each detector comprises means for determining its position.

In a further independent aspect of the invention there is provided a detector for a traffic control system, the detector comprising means for determining its position.

Preferably each position-determining means comprises GPS or GSM circuitry.

Preferably the control means is configured to control the timings of operation of the at least one signal unit in dependence upon the positions of the detectors.

The detector may further comprise wireless communication means and/or a vehicle sensor.

In another independent aspect of the invention, there is provided a controller for a traffic control system, comprising a communication device for receiving position data representative of the position of at least one vehicle detector and for receiving detection signals from the at least one vehicle detector, a processor for processing the detection signals in dependence on the position of the at least one vehicle detector to generate control signals for controlling the timings of signals displayed by at least one signal unit.

In a further independent aspect of the invention, there is provided a traffic control system comprising at least one signal unit, at least one detector, a controller for controlling the timings of signals displayed by the at least one signal unit in dependence output from the at least one detector, and position-determining apparatus for determining the position of each detector.

In another independent aspect of the invention, there is provided a method of controlling traffic comprising receiving position data representative of the position of at least one vehicle detector, receiving a detection signal from the at least one vehicle detector, processing the detection signal in dependence on the position of the at least one vehicle detector to generate a control signal for controlling the timing of signals displayed by at least one signal unit, and providing the control signal to the at least one signal unit.

In another independent aspect of the invention, there is provided a method of installation of a traffic control system comprising positioning at least one detector at a respective position, wherein the or each detector comprises means for determining its position, and the method further comprises determining the position of the or each detector using the position determining means, comparing the determined position of the or each detector to a predetermined position or range of positions and controlling an operator interface device to instruct an operator to move the detector or at least one of the detectors in dependence on the comparison.

In a further independent aspect of the invention, there is provided a method of installation of a traffic control system comprising positioning at least one detector at a respective position, wherein the or each detector comprises means for determining its own position, and the method further comprises determining the position of the or each detector using the position determining means, selecting a mode of operation and/or selecting a traffic signal control algorithm and/or determining the value of a parameter used by a traffic signal control algorithm in dependence on the position of the at least one detector, and using the selected mode of operation and/or traffic signal control algorithm to control operation of at least one signal unit.

In another independent aspect of the invention there is provided a computer program product comprising computer readable instructions executable to put into effect a method as claimed or described herein.

Preferably the control means is configured to determine the timings of operation of the at least one signal unit using at least one adaptive or non-linear algorithm.

In a further independent aspect there is provided a traffic control system comprising at least one signal unit and control means for controlling the timing of operation of the at least one signal unit in accordance with an adaptive or non-linear algorithm. The or each adaptive or non-linear algorithm may comprise, for example, a neural network algorithm.

By using such adaptive or non-linear techniques, the system may be used effectively in a wide range of different situations with a reduced need for prior analysis of the traffic situation or pre-selection of suitable parameters. That feature may be particularly useful when combined with the use of detectors or sets of detectors that can determine their own positions as installation of the system may then be particularly straightforward.

Preferably the control means is configured to select one from a plurality of pre-determined algorithms, and to control the timing of operation of the at least one signal unit according to the selected algorithm.

Preferably the system further comprises means for providing information to a road user.

In a further independent aspect there is provided a traffic control system comprising at least one signal unit, control means for controlling operation of the at least one signal unit, and means for providing information to a user.

The means for providing information may comprise a road user interface, and preferably comprises at least one display device. The at least one display device may comprise at least one display device for each approach or leg of a junction. Alternatively or additionally the means for providing information may comprise, for example, at least one speaker for broadcasting speech or other sounds to a user.

The information may comprise information concerning the timing of operation of the or each signal unit. The information may be real time information. The information may comprise current average queuing or wait time, or an estimate of the time before a driver or other user will pass through the control region, or an estimate of the number of red-green signal cycles before the driver or other user will pass through the control region. The information may comprise information concerning the system or junction where the system is installed, for instance indicating that the system is under active control, and/or that priority is being given to one or more other legs of the junction, which may occur either temporarily (for instance in the case of significant queues on other legs of the junction) or for an extended period of time (for instance in the case of anticipated increased traffic flow on the other leg or legs due to the start or finish of a public event) or permanently. The information may comprise an instruction to slow down or speed up, or a warning, or a recommended speed, or expected wait time before a traffic signal unit will change, for example change between green and red.

The information providing means is preferably controlled by the control means. The information providing means may be operated in dependence upon operation of the at least one signal unit, and may be synchronised with a signal cycle of the at least one signal unit.

The information providing means may be operated in dependence on a detection signal or signals from the at least one detector.

The information provided by the or each information providing means may be varied in dependence on traffic conditions and/or in dependence on the speed, location or other property of a detected vehicle and/or in dependence on a signal cycle or a phase of the signal cycle of the at least one signal unit and/or in dependence on the position of the information providing means, preferably the position of the information providing means relative to a signal unit and/or a traffic queue.

The or each information providing means may comprise a position-determining device, for example a GPS or GSM device. The or each information providing means may be configured to determine its position and to provide position data representative of its position to the control means. The control means may be configured to determine the position of the or each information providing means.

The control means may be configured to communicate with at least one other traffic control system, and there may further be provided means for synchronising operation of the traffic control system and the at least one other traffic control system.

The system may be produced by combining an existing traffic control system with at least one additional component.

In a further independent aspect of the invention there is provided a method of adapting an existing traffic control system, the existing traffic control system comprising at least one signal unit, the method comprising providing a plurality of detectors for each signal unit and control means for receiving signals from the detectors.

The existing traffic control system may further comprise an existing controller for controlling operation of the at least one signal unit, and the method may further comprise configuring the control means to control the existing controller.

Any feature in one aspect of the invention may be applied to another aspect of the invention, in any appropriate combination. In particular, apparatus features may be applied to method features and vice versa.

Preferred features of embodiments of the invention will now be described, purely by way of example, and with reference to the accompanying drawings in which:

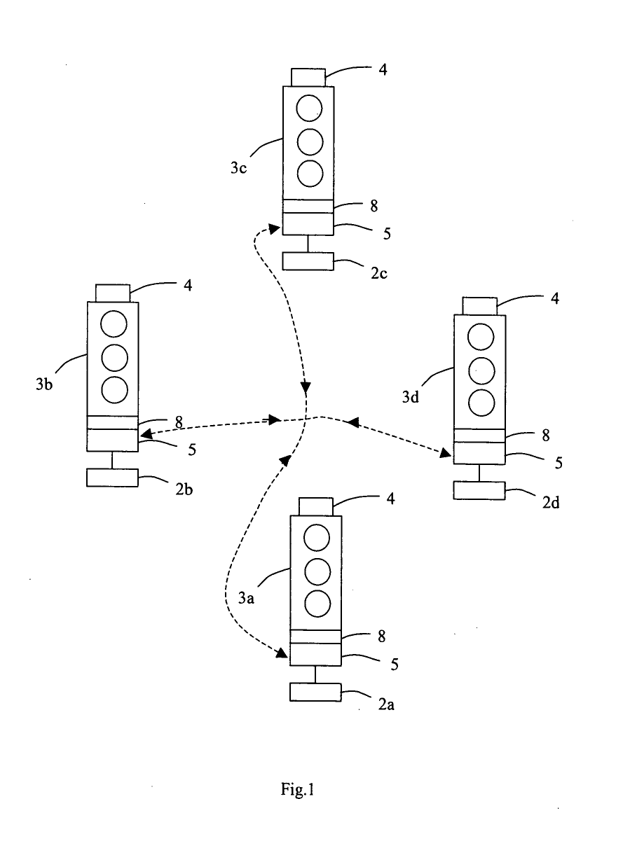

FIG. 1 is a schematic diagram of a known temporary traffic light system;

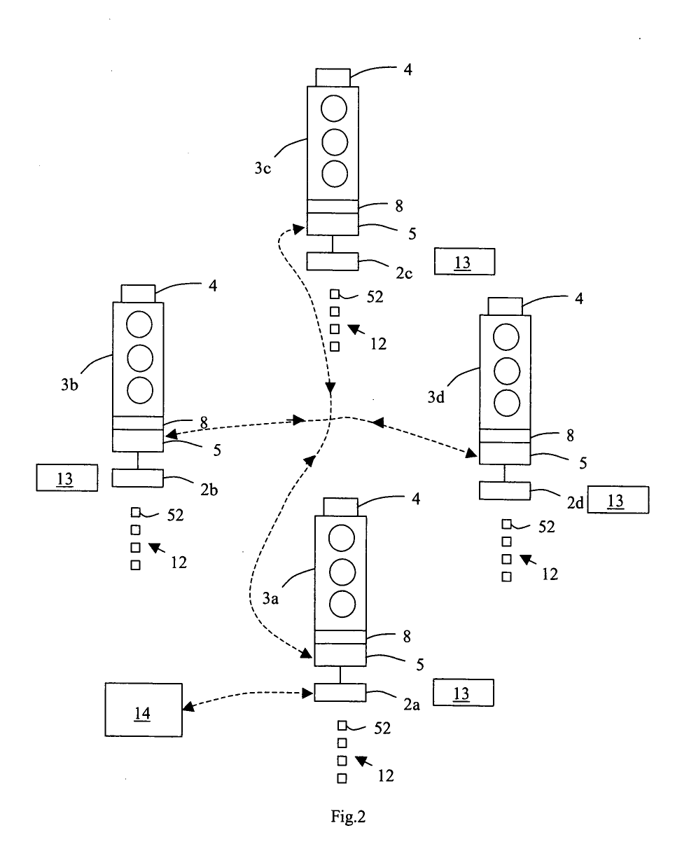

FIG. 2 is a schematic diagram of a traffic light system according to the preferred embodiment;

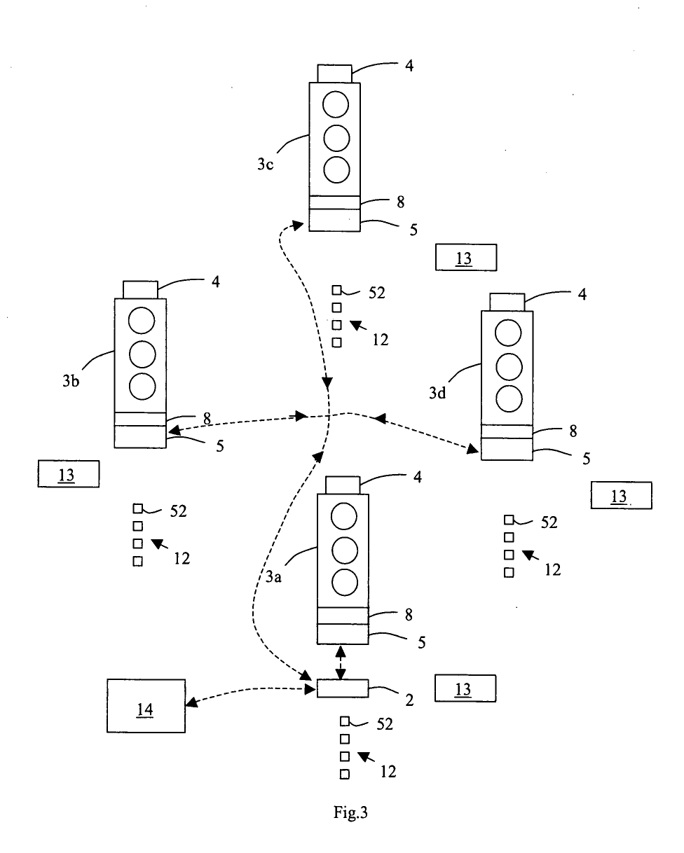

FIG. 3 is a schematic diagram of a variant of the system of FIG. 2;

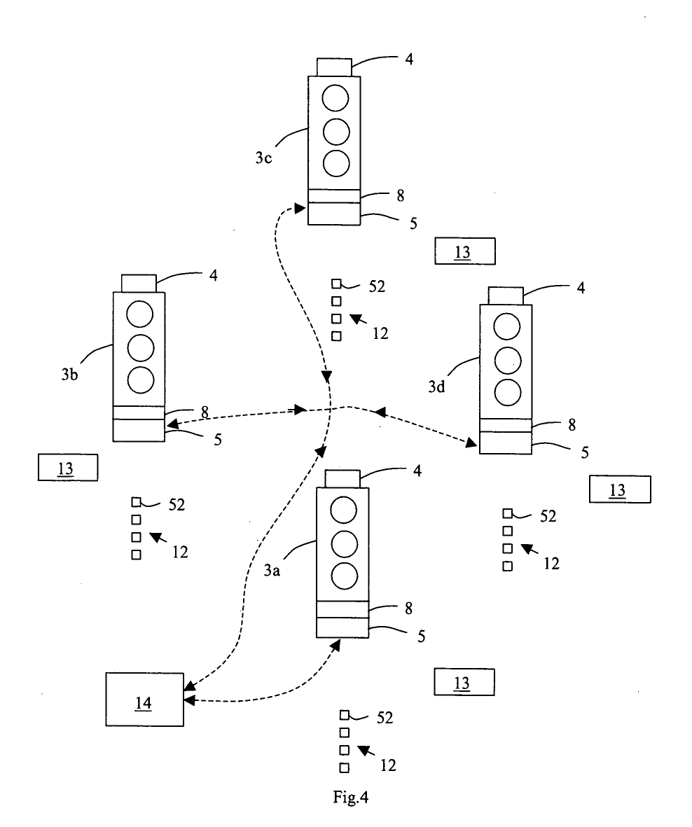

FIG. 4 is a schematic diagram of another variant of the system of FIG. 2;

FIG. 5 is a schematic diagram showing the layout of the system of FIG. 2, installed at a traffic junction;

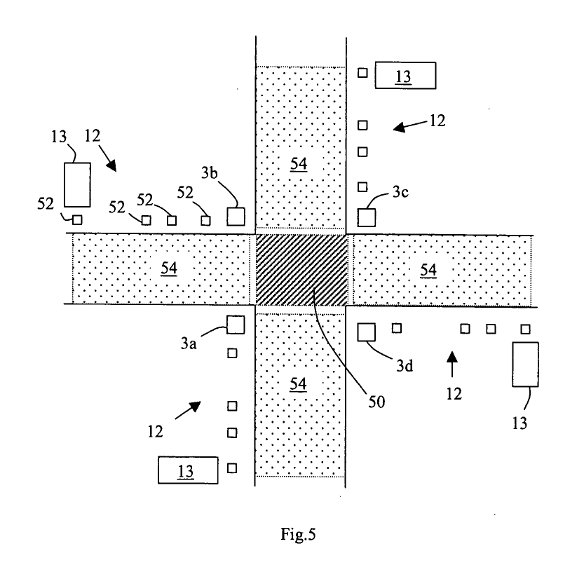

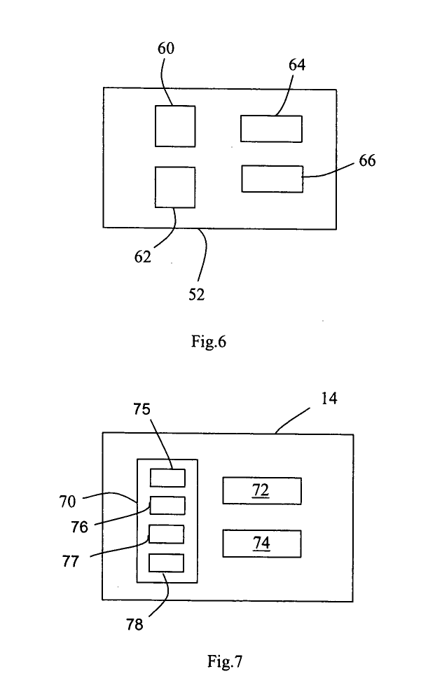

FIG. 6 is a schematic diagram of a detector;

FIG. 7 is a schematic diagram of a system controller;

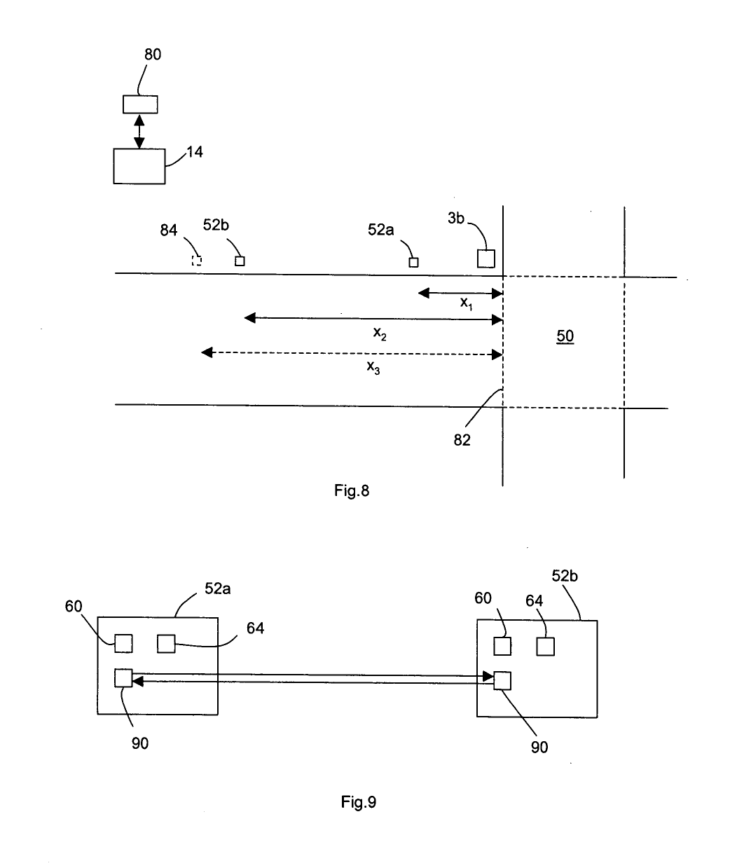

FIG. 8 is a schematic diagram showing the layout of a further embodiment, installed at a traffic junction;

FIG. 9 is a schematic diagram illustrating the determination of the relative position of detectors according to an alternative embodiment;

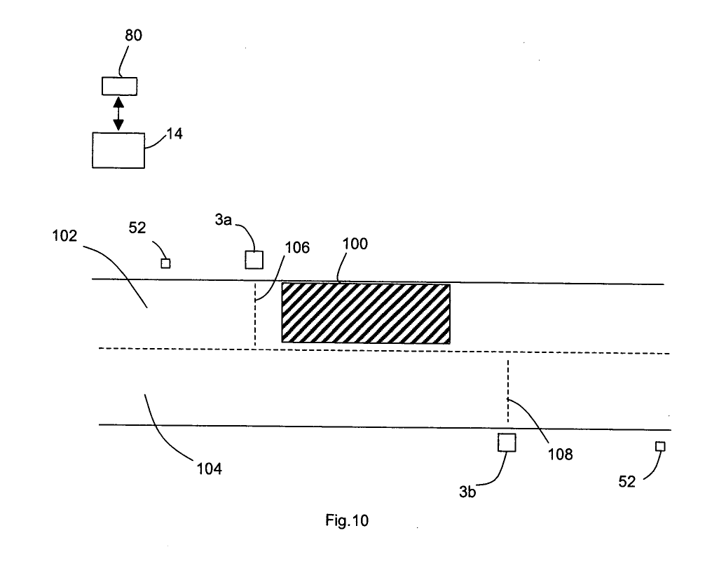

FIG. 10 is a schematic diagram showing the layout of a further embodiment, installed at road works;

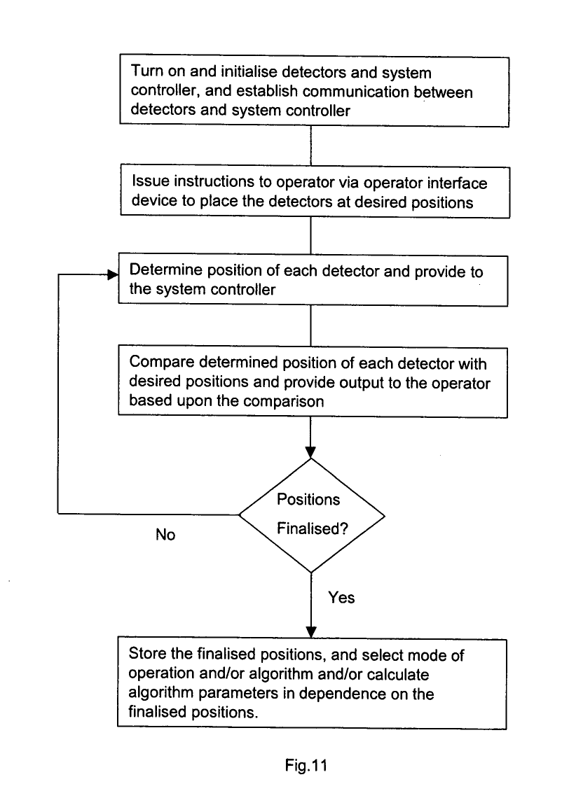

FIG. 11 is a flow chart illustrating in overview a procedure for installation of a traffic control system according to one mode of operation;

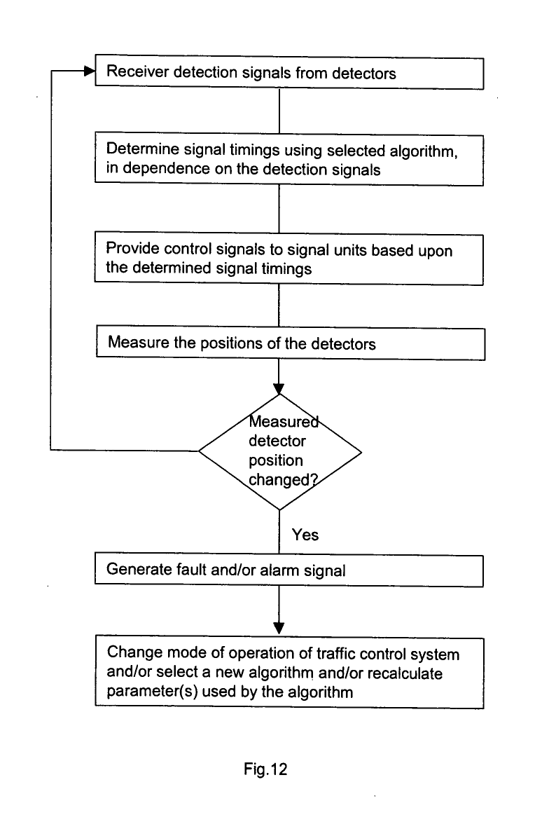

FIG. 12 is a flow chart illustrating in overview a mode of operation of a traffic control system;

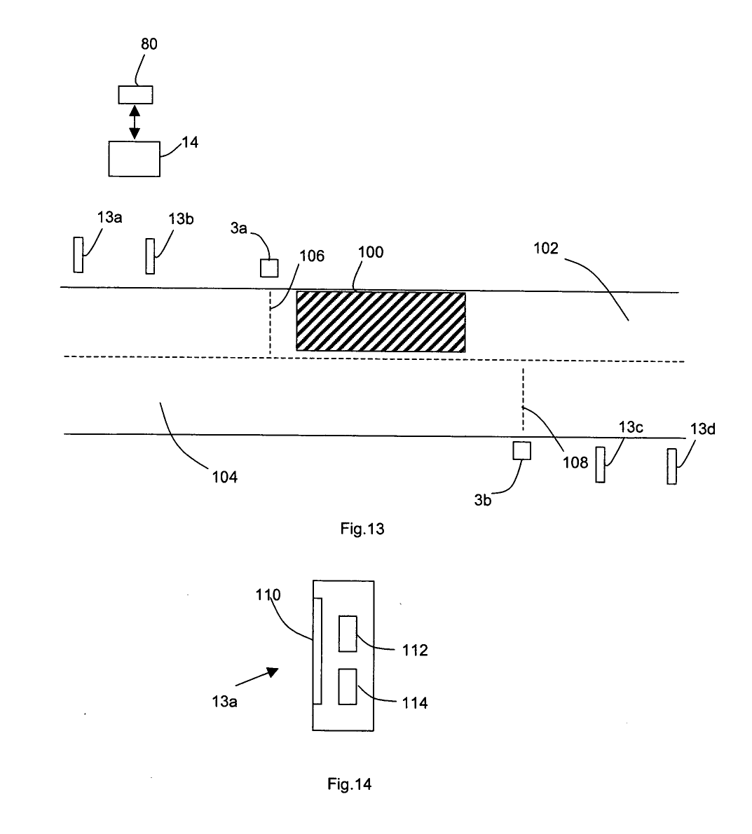

FIG. 13 is a schematic diagram of a further embodiment; and

FIG. 14 is a schematic diagram of a display device.

A known temporary traffic light system is shown in FIG. 1. The system of FIG. 1 is similar to traffic light systems described in UK patent application GB 2 435 708, in the name of Hatton Traffic Management Limited.

The system of FIG. 1 comprises a 4-phase traffic light control system and a set of traffic lights for a 4-way junction, and comprising four signal units 3a-3d, each provided with a respective controller 2a to 2d, and each connected to a respective battery (not shown). In the example of FIG. 1, the controllers 2a-2d are essentially identical. Each one is switchable to either master controller or slave controller mode operation. This is done when the control system is initially set up. In the present case the first controller 2a, is designated to be the master controller, and the other three are slave controllers 2b-2d. In a variant of the system of FIG. 1, there is a single dedicated master controller 2a and the other controllers 2b-2d are dedicated slave controllers and the controllers are not switchable between master and slave modes.

Each signal unit 3a-3d is provided with a wireless modem 5 for sending and receiving signal transmissions from one or more other controllers as appropriate. Each signal unit 3a-3d also is provided with a vehicle actuated sensor, in the form of a detector 4, and a signal head control unit 8 that controls operation of red, green and amber lights of the signal unit, in response to control instructions from the master controller. The detector 4 of FIG. 1 is a radar detector, a microwave detector, or an infrared detector.

On detecting a vehicle, the detector 4 positioned on top of each signal unit 3, generates an output signal, which is registered by the controller 2 for that signal unit. If the controller in question is not the master controller 2a then data is sent via the wireless modem 5 of the signal unit to the master controller 2a indicating that a vehicle has been detected by the signal unit in question.

The master controller controls the length of each green phase according to a vehicle actuation (VA) technique, in dependence upon the signals received from the detector 4 of its signal unit, and from the data received from the other signal units indicative of the detection of vehicles. The master controller sends control signals to the signal head control units 8, either directly in the case of the signal head control unit 8 included in the same signal unit as the master controller, or via the wireless modems in the case of the other signal head control units 8.

A manual control handset (not shown) is attachable to, or may be integrated with, the controllers 2, and can be used in the manual operation mode or for setting parameters, such as minimum or maximum green time, for other modes of operation.

The system can be set to manual operation mode, fixed time operation mode, demand responsive operation mode or all red.

In demand responsive operation mode, the control signal to begin a sequence is sent from the master controller to the signal head control unit 8 of the signal unit which registered the first demand, which then begins its sequence. If a constant demand is registered on that signal unit the light remains at green until the demand has passed. If another signal unit registers a demand the first signal unit runs out its remaining green time, turns through amber and waits for a red clearance time before the next signal unit begins a new sequence and so on. The master controller maintains a roving contact with the signal units to check for any malfunctions. If any malfunctions are registered the system sets all heads to red and then restarts.

A traffic light system according to the preferred embodiment is shown in FIG. 2, in which like features are indicated by like reference numerals. In this example, the system is a modification of the known system of FIG. 1. It is a feature of the preferred embodiment that it can be relatively straightforward to produce by modifying certain existing systems.

The system of FIG. 2 includes a system controller 14 that includes a processor and wireless communication circuitry, and that is used to control operation of the system. The system of FIG. 2 also includes a set of above ground detectors 12 associated with each signal unit 3, and a road user interface, for instance in the form of an electronic sign unit 13, associated with each signal unit 3. In the example of FIG. 2, there are four detectors 52 in each set of detectors 12. However, any suitable number of detectors may be provided in each set. In variants of the system of FIG. 2 the detectors 52 are below ground detectors rather than above ground detectors.

The system is powered through the use of, for example but not limited to, one or more of mains power, rechargeable batteries, solar cells and mobile wind turbines.

The system controller 14 is configured to communicate wirelessly with any of the controllers 2a-d. In operation the system controller usually communicates with the designated master controller 2a, and sets and varies as appropriate the signal cycle timings, including green and red times, to be used by the master controller 2a, or the algorithm to be used by the master controller 2a to set the signal cycle timings. The master controller 2a then controls operation of the signal units 3 as described above. The system controller 14 effectively uses the master controller 2a to apply system cycle timings selected by the system controller 14.

The system controller 14 sets the signal cycle timings in dependence upon signals received from the sets of detectors 12. Thus, the embodiment of FIG. 2 provides a modification of an existing system to provide additional detectors. The embodiment of FIG. 2 also provides, for example:- different algorithms for determining signal cycle times, including green and red times; for the measurement of various additional parameters and the use of those parameters in setting signal cycle times; for the automatic sensing of the position of the various detectors; for the sending of data representing position from each of the detectors or sets of detectors; for the integration of the system into a network of traffic signals; and for communication with a user. Those features will be discussed in more detail below.

A variant of the embodiment of FIG. 2 is shown in FIG. 3. In this case a single controller 2 is provided, rather than a set of controllers 2a-2d. The system controller 14 controls operation of the system by controlling operation of the controller 2, which in turn controls operation of the signal units 3.

Another variant of the embodiment of FIG. 2 is shown in FIG. 4. In this case the signal controller 14 communicates directly with the signal units, and no additional controller 2 is present.

The embodiment of FIGS. 2 and 3 are shown as modifications of existing systems, but may also be entirely purpose-made. Various connections and communications between components of the systems are shown as being wireless, but any or all of those connections or communications may be wired rather than wireless. The systems of FIGS. 2, 3 and 4 are temporary traffic light systems but may also be permanent traffic light systems.

The detectors 52, and signal units 3 of the embodiment of FIGS. 2 to 4 are shown installed at a traffic junction in FIG. 5. The signal units are used to control the flow of traffic through a control region 50 indicated by dashed lines on FIG. 5. In certain modes of operations, the system controller 14 controls system timings in dependence on at least one parameter associated with one or more monitoring zones 54, shown on FIG. 5 by dotted regions. The at least one parameter may be representative of or associated with traffic within the monitoring zone.

In the example of FIG. 5, the detectors are mounted at the roadside in the direction of travel on the approach to the control region to monitor the movement and type of traffic. In variants of the system of FIG. 5, detectors may be on both the inlet and outlet of any leg of a junction, to detect vehicles both approaching and moving away from the control region.

A detector 52 used in the system of FIGS. 2 and 5 is shown schematically in FIG. 6. In the example of FIG. 6, the detector is a self-contained unit that may be attached to a lamppost or other street furniture. Alternatively, the detector may be mounted on a dedicated post or other support. The detector unit may comprise a protective housing.

The detector 52 comprises wireless communication circuitry 60, a control processor 61, GPS or GSM circuitry 62, and a battery (not shown) or other power source or mains connection.

The detector 52 also includes a vehicle detection sensor 64 for detecting the presence or absence, or passage, of a vehicle in a detection region associated with the sensor.

In the preferred embodiment, the control processor is a Microchip PICI18F4620, which is an 8-bit flash programmable RISC processor with a variety of digital and analog I/O ports. The wireless communication circuitry comprises a TI CC2420 r.f. transceiver integrated circuit and a PCB antenna operates under the IEEE 802.15.4 protocol, and provides a 250 kbits/sec data rate using a direct sequence spread spectrum (DSSS) offset QPSK modulation format in the preferred mode of operation.

The Microchip PICI18F4620, the TI CC2420 r.f. transceiver integrated circuit and the PCB antenna are included in a 26 pin surface mount module.

The power supply for the detector in the preferred embodiment comprises a 3.5V lithium cell, for example lithium thionyl chloride D cell or Li-ion rechargeable battery. (which may be recharged by associated photovoltaic cells). The power is supplied to the module via a LDO linear regulator circuit that provides a 3V supply.

The vehicle detection sensor 64 in the preferred embodiment comprises a 40 KHz Prowave 400PT160 ultrasonic transducer, powered by a 5V input obtained from the power supply via a step-up converter circuit. In an alternative embodiment separate transmit and receive transducers (for example Prowave 400ET180 and 400ER180) are used.

The ultrasonic transducer is activated by applying a complementary (push-pull) pair of square wave signals that drive a pulse into the transducer via a MOSFET driver IC and a 1:5 step-up transformer. A diode T-R switch network enables the same transducer to then receive signals that echo back from traffic. The signals are fed through an op-amp based differential amplifier with a gain of 100, a second order bandpass filter and finally an envelope detector circuit before being fed into the control processor. In the preferred mode of operation a 20 cycle, 40 KHz pulse is used by the transducer and 10 pulses per second are transmitted. The ultrasonic transducer is mounted, if possible, at a height of 0.8 m above the ground, which corresponds to the door level (widest point) of an average small car.

It is a feature of the system that each detector may include one or more additional sensors, or may comprise other sensors in place of vehicle detection sensors 64. In the example of FIG. 6, the detector 52 also includes an air quality sensor 66.

In alternative embodiments, the detector includes a sensor for determining an environmental parameter as well as or instead of the vehicle detection sensor 64, and the controller 14 is configured to control the timing of display of traffic control signals on the signal units 3a, 3b, 3c, 3d in dependence on the environmental parameter.

Any suitable sensors may be included in the detectors. Each detector may comprise, for example, one or more of an acoustic sensor, proximity sensor, vibration sensor, visual recognition system, laser sensor, induction loop sensor, pressure sensor, radar sensor, ultrasonic sensor, infra-red sensor, transponder, air quality sensor, RFID sensor, mobile phone, piezo-electronic sensor, magnetometer sensor and temperature sensor. The RFID sensors are able to detect the presence of and/or read data from RFID tags on vehicles, if present.

As mentioned above, each detector 52 in the system of FIGS. 2 and 5 also includes GPS or GSM circuitry 62 for determining the position of the detector. Alternatively GPS or GSM circuitry 62 is provided for each set of sensors 12 rather than for each individual sensor 52.

As the detectors 52 or set of detectors 12 are able to determine their own positions using the GPS or GSM circuitry, and are also able to transmit those positions to the system controller 14, the system is particularly versatile and straightforward to set up. The detectors may not be limited to being in particular positions and the position of the detectors may be selected in dependence upon a particular junction layout or upon traffic conditions. The system controller 14 may alter the signal timings, or algorithms used to determine the system timings, automatically in dependence upon the positions of the detectors or sets of detectors.

In operation, each detector or set of detectors sends signals to the system controller 14, which generates traffic flow data from the signals. In some variants, each detector communicates with the system controller directly. In other variants, some of the detectors communicate with the system controller 14 via one or more other detectors. The detectors may thus be daisy chained, either wirelessly or via wired connections. Those variants are particularly useful when the detectors have a short communication range or where it is desired to locate at least some of the detectors a large distance from the system controller 14, which is usually located near the control region.

An example of a system controller 14 is shown in FIG. 7, and comprises a processor 70, a memory 72, communication circuitry 74, and a battery (not shown) or other power source or mains connection. The communication circuitry 74 is usually wireless communication circuitry, but in some variants that system controller 14 may comprises communication circuitry for wired communication as well as or instead of the wireless communication circuitry. The processor comprises an initialisation module 75, a traffic signal control module 76, a position monitoring module 77, and a communications module 78 for controlling transmission and reception of signals via the communication circuitry 74.

The system controller 14 can be programmed or otherwise configured to apply any one of a number of different algorithms or other processes in order to determine the signal timings. In preferred modes of operation the system controller 14 determines and/or varies signal timings in real time in dependence upon output from the detectors.

In the preferred embodiment, the system controller 14 determines one or more traffic-related parameters, such as level of flow, amount of traffic, number of vehicles waiting, type of vehicle and direction of travel from the signals from the detectors, usually in real time. In addition the system controller may determine and monitor the value of other parameters such as level of emissions, level of noise, vibration, temperature and position.

The system controller 14 processes the resulting data in real-time and calculates the most effective control sequence and/or signal timings, and instructs operation of the signal heads either directly or via controller 2. In some modes of operation, the system controller 14 is configured to determine the values of the traffic-related or other parameters for the at least one monitoring zone 54.

In one example, the system controller 14 controls signals timings in dependence on traffic volumes and/or flow rates on each approach to a junction and on average levels of pollutants produced by vehicles, such as carbon monoxide or sulphur based compounds, on each approach to a junction. If pollutant levels build up above a predetermined level then the system controller 14 may prioritise reducing the levels of stationary traffic on one or more of the approaches, if higher pollution levels are expected from stationary traffic.

In certain modes of operation, the system controller 14 applies adaptive techniques to determine the signal timings. In one such mode of operation, the controller 14 uses neural network techniques to determine the signal timings.

In another mode of operation, the system controller 14 calculates the best form of traffic signal pattern for the current level of traffic. Through prior modelling of the types of traffic flows experienced at temporary and permanent traffic control sites a set of possible signal patterns or algorithms are obtained, and those signal patterns or algorithms are stored by the system controller 14. One of those signal patterns or algorithms is selected by the system controller 14 to be used to control signal timings. The parameters of the signal pattern or algorithm may be altered in real time by the system controller 14 or another signal pattern or algorithm may be selected, as traffic characteristics or other parameters vary over time.

Many of the algorithms, in particular vehicle actuation or demand responsive algorithms, that can be used by the controller 14 to control the timings of signals displayed by the signal units 3a-3d include or are dependent on the position of the detectors.

For example, correct determination of the value of a traffic related parameter (for example the length of a queue, the speed of a vehicle or the estimated time for a detected vehicle to arrive at a signal unit) which may be used by or included in an algorithm and which is determined from the outputs of the detectors 3a-3d, depends on the correct position of the detectors being known by the controller 14. In the case of the speed of a vehicle, the value of the speed may in one example be determined from the time difference between detection of the vehicle by two spatially separated detectors, in which case it is necessary to know the separation of the detectors. In another example, an algorithm may specify that a green time is to be extended if the controller 14 determines from outputs from the detectors that a vehicle is detected (and/or is moving at above a predetermined speed) within a predetermined distance of a signal unit 3a or stop line, which again requires that the controller 14 knows the correct position of the detectors 52a, 52b. In a further example, an algorithm comprises the feature of extending a green time if a vehicle is detected by a detector that is at a position that is such that the vehicle would be expected to reach a signal unit within a predetermined time (for example 4 seconds) based upon a measured or expected speed, which requires that the controller knows the correct position of the detectors.

In the case of permanent, fixed traffic lights, detector positions are often pre-specified positions, or are within pre-specified ranges, optimised for a particular algorithm and usually do not change after installation as the detectors are permanently installed. In contrast, in the case of temporary or portable traffic light systems, it may not be possible to place detectors in pre-specified or optimum positions, and the detectors may be moved subsequently by the operator (for example, as roadworks change or move). Furthermore, the detectors used in temporary or portable traffic light systems are usually above ground detectors that are temporarily installed and may be subject to accidental or unauthorised movement, which can disrupt or cause significant errors in operation of the system

The feature that the system is able to determine the position of each detector (for example using GPS or GSM circuitry for determining the position of the detector in the embodiments of FIGS. 2 to 6) can thus be particularly important in the case of temporary or portable traffic lights, and an embodiment in which the position of the detectors is determined automatically by the system is described in more detail in relation to FIG. 8.

FIG. 8 shows an embodiment that is a variant of the embodiment of FIG. 5, and in which a temporary or portable set of traffic lights is installed at a traffic junction. The traffic junction includes a control region 50 that in this example is bounded by stop lines 82. For clarity, components of the system are only shown for one leg of the junction in FIG. 8. In the embodiment of FIG. 8, two vehicle detectors 52a, 52b are provided on each leg of the junction, but any number of vehicle detectors may be provided on each leg. The system includes an operator interface device 80 that is in communication with the system controller 14 of FIG. 8.

In the embodiment of FIG. 8 the operator interface device 80 is a laptop computer that is connected via a wired connection (for example a USB connection) or wireless connection to a port on the system controller 14. In alternative embodiments, the operator interface device 80 is built-in to the system controller 14.

In order to install the system, the detectors 52a, 52b, and the system controller 14 are turned on and initialised. Wireless communication is established between the detectors 52a, 52b and the system controller 14 and the GPS or GSM circuitry 62 of the detectors 52a, 52b operates to determine the position of each detector 52a, 52b.

An instruction is issued to the operator by the initialisation module 75 of the system controller 14 via the operator interface device 80 to place the detectors 52a, 52b at desired positions (for example at distances 10 m and 50 m from the stop line 82, or at pre-determined distances from another reference point). The detectors 52a, 52b are moved by the operator or a colleagues of the operator approximately to the desired positions.

The positions of the detectors 52a, 52b are periodically determined by the GPS or GSM circuitry 62 of each detector during the installation process, and position data representative of the positions of the detectors 52a, 52b is transmitted from the detectors 52a, 52b to the system controller 14 by the wireless communication circuitry 60. In a related example, the positions of the detectors 52a, 52b is measured by the operator using a separate measuring device (for example a tape measure or a handheld GPS unit) and position data representative of the positions of the detectors 52a, 52b is input by the operator to the controller 14 (for example via the operator interface device 80).

The position monitoring module 77 of the system controller 14 determines from the position data the distances of the detectors 52a, 52b from the stop line 82 or other reference point. The position of the stop line 82 or other reference point is pre-determined and stored in the memory 72 of the system controller 14, or can be determined using a GPS unit and entered either manually or automatically into the memory 72 of the system controller 14. In an alternative embodiment, the signal units 3b includes GPS or GSM circuitry for determining the position of the signal unit 3b, and the positions of the signal unit 3b is provided to the system controller 14 via wireless modem 5 and used as the reference point.

The system controller 14 then outputs further instructions or other communications to the operator via the operator interface device 80, indicating the position of the detectors 52a, 52b relative to the desired positions (for example “Move most distant detector a further 5 m from the stop line” or “Actual position 45m, desired position 50m”).

Once the detectors 52a, 52b are at the desired positions, or within a predetermined threshold distance (for example, 1 m) of the desired positions, the system controller 14 instructs the operator to fix the detector 52a, 52b at those position. Alternatively, if the operator is not able to fix the detectors 52a, 52b at the desired positions, the operator can input to the system controller 14 via the operator interface device 80 that the detectors 52a, 52b are to be fixed at their current positions. The initialisation module 75 stores the positions of the detectors 52a, 52b in the memory 72. The same procedure is followed for each leg of the junction.

The operator is able to select a mode of operation for the traffic lights via the operator interface device 80, for example all red, fixed time or demand responsive/vehicle actuated. Alternatively the system controller 14 selects the mode of operation automatically.

A set of signal timing algorithms, and parameters for those signal timing algorithms are stored in the memory 72. The initialisation module 75 selects one of the signal timing algorithms in dependence on the mode of operation that has been selected and/or in dependence on the positions of the detectors. The initialisation module may also calculate values of parameters to be used by the selected signal timing algorithm using the determined positions of the detectors.

Control of the signal units 3a-3d is then passed to the traffic signal control module 76, and the signals units are operated in accordance with the selected mode of operation and/or algorithm. The traffic signal control module 76 receives detection signals from the detectors 52a, 52b (and from the detectors of the other legs of the junction), processes the detection signals in dependence on the position of the detectors to generate control signals for controlling the timings of signals displayed by the signal units 3a-3d, and provides the control signals to the signal units 3a-3d.

During normal operation of the signal units, the detectors 52a, 52d (and the detectors of the other legs of the junction) continue to determine their positions using the GPS or GSM circuitry 62 and to transmit position data representative of their positions to the system controller 14 using the communication circuitry 60. The position monitoring module 77 receives the position data and determines whether there has been any change in position of a detector.

If there has been a change of position of a detector that is greater than a predetermined threshold amount (for example 50 cm), or if the system controller 14 ceases to receive valid position data from a detector then the position monitoring module 77 generates an output signal, for example an alarm or fault signal, and provides the output signal to an operator, either via the operator interface device 80 (if it is still in communication with the system controller 14) or via communication with a further device (not shown) for example a mobile telephone, or a network controller.

The position monitoring module 77 can also be configured to switch the system automatically to a different mode of operation (for example fixed time operation) and/or to select a new algorithm and/or to recalculate parameters used by the algorithm if the position of a detector changes or if the or if the system controller 14 ceases to receive valid position data from a detector. A change in position of detector 52b to a new position 84 is shown schematically in FIG. 8.

The position monitoring module 77 can be configured so that the action that is taken is dependent on the size of the detected movement of the detector and/or on whether there seems to be a fault with a detector. If the change in position is relatively small (for example up to 10 m) then the position monitoring module 77 can be configured to update the stored position of the detectors, to recalculate values of parameters used by the algorithm and/or to amend the algorithm in light of the change of position, and to continue with a demand responsive/vehicle actuated mode of operation.

If the change in position is relatively large and/or if the position monitoring module 77 determines from the received position data (or from an absence of received position data) that there is a fault, then the position monitoring module 77 usually switches the system to fixed time operation or to all red operation.

If a detector has been removed without authorisation then the position monitoring module 77 continues to monitor the position of the detector and to output the position to the operator, which can aid in recovery of the detector.

In the embodiment of FIG. 8, each detector 52a, 52b includes GPS or GSM circuitry that is operable to determine the position of the detector 52a, 52b from GPS or GSM signals received by the GPS or GSM circuitry. In alternative embodiments, GPS, GSM or other communication circuitry is used to transmit signals to a remote device (not shown), for example a network controller, that is operable to communicate with the system controller 14. The position of the detector 52a, 52b is then calculated at the remote device or at the system controller. Thus, in those alternative embodiments each detector 52a, 52b includes components used for determining the position of the detector, but the actual calculation of the position is performed at the system controller 14 or the remote device.

A further alternative embodiment is illustrated in FIG. 9, in which the position of each detector 52a, 52b is determined in dependence on the time of flight of a signal transmitted by the one of the detectors 52a, 52b to the other of the detectors 52b, 52a. In this embodiment, the GPS or GSM circuitry of each detector is replaced by a transceiver module 90 for transmitting and receiving ultrasonic or electromagnetic signals (for example, r.f., microwave or laser light signals). A signal transmitted by one of the receivers 52a is received by the other receiver 52b and a response signal is transmitted to the receiver 52a by the other receiver 52b. Alternatively the signal transmitted by the receiver 52a is reflected by the other receiver 52b. The relative positions of the receivers 52a, 52b, in this example their distance apart, is determined by the transceiver module from the time difference between transmission of a signal and receipt of the response signal or reflected signal. The transceivers can be configured to operate synchronously in order to determine accurately the time difference. A transceiver module 90 can also be included in the system controller 14 or the signal unit 3b in order to determine the distance of the or each detector 52a, 52b from the controller 14 or the signal unit 3b. In the embodiments of FIG. 6 and FIG. 9 a control processor for controlling operation of the detector 52 can be included within one of the components 60, 62, 64, 66, 90 or a separate control processor can be included in the detector 52.

Another alternative embodiment is illustrated in FIG. 10, in which the traffic control system is used to control traffic through an area of roadworks 100. In this example, carriageways 102, 104 approaching the roadworks 100 from different directions can be treated as different legs of junction. A signal unit 3a, 3b is provided for each carriageway 102, 104. The positions of the detectors are determined relative to the signal units 3a, 3b which are installed adjacent to temporary stop lines 106, 108. A single detector 52 is provided for each signal unit 3a, 3b. The installation and operation of the traffic control system of FIG. 10 is the same as that of FIG. 9. Flow charts illustrating in overview installation and operation procedures of the embodiments of FIGS. 9 and 10 are provided in FIGS. 11 and 12.

The road user interfaces 13 in the preferred embodiment are, for example, LED based lighting boards, and are controlled by the system controller 14. Alternatively, the road user interfaces may be any other suitable display devices. Each board or other display device is able to communicate with the system controller 14 and to indicate to a driver or other user information specific to the control site or roadway where the system is installed, or concerning operation of the system, or concerning traffic flow through the junction. The information may be real time information. In one example, a road user interface 13 may be used to indicate, for example, current average queuing or wait time at that approach to the control region, or an estimate of the time before the driver or other user will pass through the control region, or an estimate of the number of red-green signal cycles before the driver or other user will pass through the control region. The road user interface 13 may also provide other information concerning the system or junction where it is installed, for instance indicating that the system is under active control, and/or that priority is being given to one or more other legs of the junction, which may occur either temporarily (for instance in the case of significant queues on other legs of the junction) or for an extended period of time (for instance in the case of anticipated increased traffic flow on the other leg or legs due to the start or finish of a public event) or permanently.

Each road user interface 13 can be located at or near a signal unit 3, but is often located remotely on the approach to a signal unit, in order to provide advance information to road users.

An embodiment of a traffic control system in which several display devices 13a, 13b, 13c, 13d in the form of electronic signs are provided on each approach to a set of roadworks is illustrated in FIG. 13 (which is not to scale). The embodiment is a variant of the embodiment of FIG. 10 and also includes detectors 52, which are not shown in FIG. 13 for clarity.

Two electronic signs 13a, 13b or 13c, 13d are provided for each carriageway on the approach to the roadworks. Each electronic sign includes an LCD display area 110, a sign controller 112 and wireless circuitry 114 for communication with the system controller 14, as illustrated in FIG. 14. The system controller 14 controls the information that is displayed by each electronic sign 13a, 13b, 13c, 13d by sending control signals to the sign controller 112 via the wireless circuitry 114 for that electronic sign.

The information that is displayed by each electronic sign can be linked to the traffic control procedure applied by the system controller 14 and to traffic conditions detected by the detectors 52. The information that is displayed by each electronic sign can also be synchronised with the timing of the operation of the signal units.

For example, if traffic is queuing in advance of the roadworks the electronic signs 13a, 13b can be controlled to display information indicating that there is a traffic queue and/or the length of the queue or queuing time.

If there is a traffic queue and electronic sign 13a is in advance of the start of the queue, it can be controlled to display the message “Roadworks ahead. Traffic queuing. Current queue time 5 minutes”. If electronic sign 13b is at a location after the start of the queue, it can be controlled to display the message “Queue time from here 3 minutes”.

If there is no queue then one or both of electronic signs 13a, 13b may be controlled to display the message “Roadworks ahead. Temporary traffic lights. No queue at present”.

In another mode of operation, the controller 14 is configured to estimate a threshold or optimum speed of a vehicle approaching the signal units in order to maintain a desired rate of flow of vehicles through the roadworks. The estimate may be based upon the speed of vehicles approaching the signal units measured by the detectors and may be synchronised with the timing of operation of the signal units. For example if the controller calculates that an approaching vehicle or vehicles will not pass through the traffic lights before they turn to red, it may control the electronic signs 13a, 13b to issue the message “Slow down. Traffic lights approaching” and/or display a hazard or warning sign. Alternatively, if the controller calculates that the vehicle or vehicles are approaching the traffic lights at a speed that means the signal unit 3a will display a green signal on arrival, it may provide no information or may provide the message “Please maintain your speed.”

In a variant of the embodiment of FIG. 14, each electronic sign includes GPS or GSM circuitry and is configured to determine its position and to provide its position to the controller 14. The controller 14 can control the information displayed by each electronic sign in dependence on the position of the electronic sign.

The system controller 14 may communicate with other traffic control systems or networks, either via wired or wireless links, operation of the system may be linked to operation of those other systems or networks. In one example, the system is a temporary traffic control system and its operation is integrated, via the system controller 14, into a demand-responsive network of permanent traffic signals, with the system controller 14 of the temporary system being in communication with, and/or controlled by, the controller of the network.

The system may interface with the local and national transport road sign network. The system may also incorporate an emergency green wave application, run for instance on the controller 14, which can be integrated with a local demand responsive signal control network or other local traffic control systems.

In variants of the system, the sets of detectors 12 and the system controller 14 are used with or without the signal units 3 and signs 13 for data collection and logging. Data may be stored in the system controller 14 and downloaded on disc, tape or chip or may be transmitted directly to a remote point.

A further example of the installation of a temporary traffic control system, such as that of FIG. 2 is now described. Firstly, a group of signal units 3 are placed in sequence around a control region. A set of detectors 12 and mounts are placed, for example, from 1 m to 500 m from the signal units. Each set of detectors 12 may comprise any number of detectors 52 depending on the site, and may for example have between one and ten detectors for each approach or leg. At the point where traffic enters the system a driver interface sign 13 is placed to communicate with the road user. The signs 13 and detectors 52 are connected (either by wire or wirelessly) to a system controller 14 within a control box. A signal unit controller 2 is connected to the system controller 14 and to the signal units 2.

Once the hardware is in place, the system controller 14, signs 13 and detectors 52 are switched on and synchronised. Each sign 13 is instructed to display a message, as appropriate. Each signal unit 3 is switched on. The signal unit controller 2 is now started and synchronises with the signal units 3. The system controller 14 and signal unit controller 2 are synchronised. The signal unit controller 2 is then programmed with an initial set of signal timings, either by an operator or automatically by the system controller 14, and the signal timing cycle is commenced. The system controller 14 then calculates the best signal timing cycle or program for the current level of traffic flow or other parameters and sends that to the signal unit controller 2. The detectors continuously communicate with the system controller 14 which varies the signal timing cycle or program or the parameters of the signal timing cycle or program dependent on outputs from the detectors in real time.

It will be understood that the invention has been described above purely by way of example, and modifications of detail can be made within the scope of the invention.

Each feature disclosed in the description and (where appropriate) the drawings may be provided independently or in any appropriate combination.

1-35. (canceled)

36. A traffic control system comprising at least one signal unit, at least one detector, a controller for controlling the timings of signals displayed by the at least one signal unit in dependence upon output from the at least one detector, and position-determining apparatus for determining the position of the or each detector.

37. A system according to claim 36, wherein the controller is configured to control the timings of operation of the at least one signal unit in dependence upon the position of the at least one detector.

38. A system according to claim 36, wherein each detector comprises means for determining its position.

39. A system according to claim 37, wherein the or each position-determining means comprises GPS or GSM circuitry.

40. A system according to claim 36, wherein the controller is configured to use an algorithm to determine the timings of operation of the at least one signal unit, and is further configured to select or alter the algorithm in dependence upon the position of the or each detector.

41. A system according to claim 36, wherein the controller is configured to monitor the position of the detector or at least one of the detectors and to provide a signal in response to a change in position of the detector or at least one of the detectors.

42. A system according to claim 36, wherein the controller is configured to monitor the position of at least one of the detectors and to alter operation of the traffic control system in dependence on whether the position of the or at least one of the detectors changes.

43. A system according to claim 36, wherein the controller is operable to control the timings of signals displayed by the at least one signal unit according to at least a first mode of operation and a second mode of operation, and is configured to switch from the first mode of operation to the second mode of operation in dependence on whether the position of the detector or at least one of the detectors changes.

44. A system according to claim 43, wherein the second mode of operation comprises using an algorithm to control the signal timings that is not dependent on the position of the at least one detector.

45. A system according to claim 43, wherein the first mode of operation comprises a demand-responsive operation mode, and/or the second mode of operation comprises one of a fixed time operation mode, an all-red operation mode and a manual operation mode.

46. A system according to claim 36, wherein the detector or at least one of the detectors is configured to monitor its position and to transmit a change of position signal in response to a change in position.

47. A system according to claim 36, wherein the or each detector comprises a vehicle detection sensor.

48. A system according to claim 36, wherein the controller is configured to perform a system installation procedure comprising comparing the position of the or each detector to a predetermined position or range of positions and controlling an operator interface device to instruct the operator to move the detector or at least one of the detectors in dependence on the comparison.

49. A system according to claim 36, wherein the controller is configured to perform a system installation procedure comprising selecting a mode of operation and/or selecting a traffic signal control algorithm and/or determining the value of a parameter used by a traffic signal control algorithm in dependence on the position of the at least one detector.

50. A system according to claim 36, wherein the at least one signal unit is a temporary or portable signal unit.

51. A detector for a traffic control system, the detector comprising means for determining its position.

52. A detector according to claim 51, wherein the position determining means comprises GPS or GSM circuitry.

53. A detector according to claim 51, further comprising at least one of wireless communication circuitry and a vehicle sensor.

54. A controller for a traffic control system, comprising a communication device for receiving position data representative of the position of at least one vehicle detector and for receiving detection signals from the at least one vehicle detector, and a processor for processing the detection signals in dependence on the position of the at least one vehicle detector to generate control signals for controlling the timings of signals displayed by at least one signal unit.

55. A method of controlling traffic comprising receiving position data representative of the position of at least one vehicle detector, receiving a detection signal from the at least one vehicle detector, processing the detection signal in dependence on the position of the at least one vehicle detector to generate a control signal for controlling the timing of signals displayed by at least one signal unit, and providing the control signal to the at least one signal unit.

56. A method of installation of a traffic control system comprising positioning at least one detector at a respective position, wherein the or each detector comprises position determining apparatus for determining its position, and the method further comprises determining the position of the or each detector using the position determining apparatus, comparing the determined position of the or each detector to a predetermined position or range of positions and controlling an operator interface device to instruct an operator to move the detector or at least one of the detectors in dependence on the comparison.

57. A computer program product comprising computer readable instructions executable to put into effect a method according to claim 56.
